(19) United States
(12) Patent Application Publication
(10) Pub. No.: US 2021/0215080 A1
(43) Pub. Date: Jul. 15, 2021

(54) HEATING DEVICE FOR INSTALLATION IN A VEHICLE TANK FOR REDUCING AGENT AND VEHICLE TANK

(71) Applicant: Vitesco Technologies GMBH, Hannover (DE)

(72) Inventors: Jan Hodgson, Troisdorf (DE); Christian Vorsmann, Gaggenau (DE)

(73) Assignee: Vitesco Technologies GMBH, Hannover (DE)

(21) Appl. No.: 17/213,531

(22) Filed: Mar. 26, 2021

Related U.S. Application Data
(63) Continuation of application No. PCT/EP2019/076575, filed on Oct. 1, 2019.

(30) Foreign Application Priority Data
Oct. 2, 2018 (DE) 10 2018 216 929.2

(51) Int. Cl. F01N 3/20; F24H 1/20; F24H 1/00; F24H 9/18

(52) U.S. Cl. CPC F01N 3/2066; F24H 1/202; F24H 1/009; F24H 2250/04; F01N 2610/10; F01N 2610/1406; F24H 9/1827

(57) ABSTRACT

A heating device for installation in a vehicle tank for reducing agent, which is introduced into an exhaust tract of a motor vehicle for exhaust gas aftertreatment. The heating device includes at least one electrical heating element and a heat distribution body, wherein the at least one electrical heating element includes a PTC heating element, and wherein the PTC heating element is arranged in thermally conductive contact with the heat distribution body. According to the invention, the heat distribution body has a heat conduction device which is designed to distribute heat from the PTC heating element in a targeted manner within the heat distribution body. The invention also specifies a vehicle tank with such a heating device.

### CROSS-REFERENCE TO RELATED APPLICATIONS

This application claims priority to PCT Application PCT/EP2019/076575, filed Oct. 1, 2019, which claims priority to German Patent Application No. DE 10 2018 216 929.2, filed Oct. 2, 2018. The disclosures of the above applications are incorporated herein by reference.

### FIELD OF THE INVENTION

The invention relates to a heating device for installation in a vehicle tank for reducing agent, which is introduced into an exhaust tract of a motor vehicle for exhaust gas aftertreatment, including at least one electrical heating element and a heat distribution body, wherein the at least one electrical heating element includes a PTC heating element which is arranged in thermally conductive contact with the heat distribution body. The heat distribution body here is formed from a first material which has a first thermal conductivity, wherein the heat distribution body is configured to transport and release heat generated by the PTC heating element. The invention also relates to a vehicle tank for a motor vehicle, which is designed to store a reducing agent which is introduced into an exhaust tract of the motor vehicle for exhaust gas aftertreatment, with a heating device of this type.

### BACKGROUND OF THE INVENTION

For reducing the emission of nitrogen oxide in the case of motor vehicles having an internal combustion engine, it is known, within the scope of the selective catalytic reduction (SCR) process, to inject a liquid reducing agent into the exhaust gas flow in order to convert the nitrogen oxides (NOx) contained in the exhaust gas flow into harmless components, such as nitrogen (N2) and water (H2O), by use of a catalytic converter. The reducing agent usually used is ammonia (NH3) and/or a reducing agent precursor, such as, for example, urea (CH4N2O) or a urea-water solution. A reducing agent precursor that has already been tried and tested is a 32.5% strength urea-water solution, which is available under the trade name AdBlue®.

To store the liquid reducing agent, a tank is provided which interacts with a delivery unit such that the reducing agent may be delivered from the tank to the exhaust gas flow. For the delivery and storage of liquid reducing agent, it has to be taken into consideration that the liquid reducing agent, which in an embodiment is an aqueous urea solution, may at least partially freeze. The freezing point of the reducing agent precursor AdBlue® is usually around −11° C.

This leads to the problem that precisely when the motor vehicle is cold-started or restarted, there is no or very limited reducing agent in liquid form which may be fed to the exhaust system. Nevertheless, it has to be ensured that the nitrogen oxides in the exhaust gas flow are reduced even at very low temperatures in the vicinity of the motor vehicle. Measures are therefore required to reduce freezing and/or to enable rapid thawing of frozen reducing agent in the tank. For this purpose, the tank for storing the reducing agent is usually equipped with a heating device in order, at low temperatures, to keep at least part of the reducing agent in the tank liquid, or to liquefy same, such that it may still be introduced into the exhaust gas flow.

Such a heating device generally includes a PTC (positive temperature coefficient) heating element. Such a thermistor, also referred to as a PTC thermistor, converts electrical current into heat and has a dependence of the electrical resistance on the temperature. The PTC heating element thus has a low electrical resistance at low temperatures, which multiplies exponentially when a defined switching temperature is exceeded. This property means that the PTC heating element is self-regulating: at low temperatures, a high current flows and the PTC heating element heats up rapidly and has a high heat output. Once the switching temperature is reached, the current through the PTC element is reduced and the temperature is prevented from rising significantly above the switching temperature, with the heat output being reduced accordingly.

A heating device and a vehicle tank of the type mentioned at the beginning are disclosed, for example, in DE 10 2006 027 487 A1. The heating device is arranged in the vehicle tank for a liquid reducing agent and includes a flat aluminum body, designed as a heat distribution body, in which a plurality of electrical heating elements are integrated. The electrical heating elements are PTC heating elements that release heat to the flat aluminum body. The heat is dissipated to the reducing agent via the aluminum body. This heating device is intended to enable frozen reducing agent to be thawed such that liquid reducing agent is available even at low temperatures and may be fed to the exhaust system via a delivery module.

Furthermore, DE 10 2007 059 848 A1 describes a heating device that is introduced into a tank for AdBlue®. The heating device has a heating resistor with a positive temperature coefficient, which is surrounded by a ribbed aluminum body.

EP 1 767 417 A1 likewise discloses a tank for a urea solution with a heating device arranged in the tank. The heating device has a rod-shaped PTC heating element which is connected in a thermally conductive manner to a heat distribution element. The heat distribution element has a fusible sleeve with a plurality of plate-like de-icing surfaces. During operation, heat is conducted from the PTC heating element via the fusible sleeve to the de-icing surfaces of the heat distribution element such that the heat is transferred, substantially via the de-icing surfaces, into the urea solution frozen in the tank.

In heating devices of this type, however, it is disadvantageous that the heat generated by the PTC heating element and transferred to the heat distribution body is released by the latter in a substantially uncontrolled manner to the environment and/or to the reducing agent. This may result, especially when the reducing agent level in the vehicle tank is low, in more heat being transferred from the PTC heating element to the heat distribution body per unit of time than is passed on and released by the heat distribution body per unit of time. As a result, the temperature of the PTC heating element rises, which ultimately leads to a reduction in the heat output or to the PTC heating element being switched off. In such a case, at least temporarily, only a reduced or no heat output is available for heating the reducing agent.

### SUMMARY OF THE INVENTION

It is therefore a first object of the invention to specify a heating device for installation in a liquid tank for reducing agent, which is introduced into an exhaust tract of a motor vehicle for exhaust gas aftertreatment, the heating device ensuring that the reducing agent is heated as reliably and rapidly as possible with a heat output which is as uniform as possible. The invention is also based on the second object of specifying a vehicle tank for a motor vehicle, which is designed to store a reducing agent which is introduced into an exhaust tract of a motor vehicle for exhaust gas aftertreatment, with a heating device, in which vehicle tank the reducing agent is heated as reliably and rapidly as possible with a heat output which is as uniform as possible being ensured.

The first object is achieved according to the invention by the features described herein. Embodiments and developments are set out in the following description.

Accordingly, a heating device for installation in a vehicle tank for reducing agent, which is introduced into an exhaust tract of a motor vehicle, includes, in a known manner, at least one electrical heating element and a heat distribution body, wherein the at least one electrical heating element includes a PTC heating element which is arranged in thermally conductive contact with the heat distribution body. The heat distribution body here is formed from a first material which has a first thermal conductivity, wherein the heat distribution body is configured to transport and release heat generated by the PTC heating element.

According to the invention, a heat conduction device is arranged on and/or in the heat distribution body, which is formed from a second material which has a second thermal conductivity different from the first thermal conductivity, wherein the heat conduction device is designed to distribute heat from the PTC heating element in a targeted manner within the heat distribution body.

The invention is based on the consideration that an efficient heating of reducing agent in a vehicle tank is achieved if the heat output of a PTC heating element is as uniform and high as possible without a significant increase in the temperature of the PTC heating element, for example an increase of the temperature to or above the switching temperature of the PTC heating element. The invention is also based on the consideration that reliable and rapid heating of the reducing agent with a uniform heat output is further promoted by heating the entire heat distribution body as far as possible, regardless of the fill level of the reducing agent in the vehicle tank. The invention therefore provides that the heat distribution body has a heat conduction device which is arranged on and/or in the heat distribution body and which is formed from a second material, which has a thermal conductivity different from the first material of the heat distribution body, and which is designed to distribute heat from the PTC heating element in a targeted manner within the heat distribution body. As a result, the heat conduction by the heat distribution body may be influenced in such a manner that the heat conduction extends over the entire heat distribution body and thus the heat distribution body is heated as completely as possible, and therefore in principle a greatest possible surface area of the heat distribution body is available for dissipating the heat. This contributes to the fact that the heat flow introduced by the PTC heating element into the heating device corresponds approximately to the heat flow that is released by the heat distribution body to the environment and/or to the reducing agent, as a result of which the risk of “switching off” of the PTC heating element due to an excessively high temperature is significantly reduced and enables efficient heating of the reducing agent largely independently of the fill level in the vehicle tank.

The embodiment according to the invention has a heating device thereby provided in which, in an embodiment, a significant heat flow is established within the heat distribution body and which ensures heating of the reducing agent as reliably and rapidly as possible with a heat output which is as uniform as possible.

The term reducing agent used includes a reducing agent, such as ammonia, and a reducing agent solution, a reducing agent precursor, such as urea, and a reducing agent precursor solution, such as AdBlue®.

The heat distribution body is designed in an embodiment to transport or conduct the heat generated by the PTC heating element and transferred to the heat distribution body to regions further away from the PTC heating element and to release heat to the reducing agent and/or to the environment.

The heat distribution body may be in direct contact with the PTC heating element. In an embodiment of the invention, the heat distribution body has a contact surface on which the PTC heating element lies, at least in some regions, wherein the heat conduction device includes a coupling element which is arranged directly between a side surface, facing the contact surface, of the PTC heating element and the contact surface. The second material of the coupling element has a higher second thermal conductivity than the first thermal conductivity. In this way, a good thermal coupling of the PTC heating element to the heat distribution body and as targeted an introduction of the heat into the heat distribution body as possible is achieved. The coupling element is preferably designed to be larger in area than the side surface, facing the contact surface, of the PTC heating element, and therefore as large a contact area as possible is formed between the contact surface of the heat conduction device and the coupling element, via which heat may be dissipated from the coupling element to the heat distribution body.

The coupling element is an embodiment produced from a second material that has a significantly higher second thermal conductivity than the first thermal conductivity. The coupling element is in an embodiment a metal body, preferably a metal foil or a metal sheet. Metals generally have a high thermal conductivity. By using a metal foil or a metal sheet, a coupling element with a low weight is provided, which moreover requires little installation space.

In a further embodiment, the heat conduction device includes at least one thermal insulation layer which is arranged at least in some regions on the surface of the heat distribution body. The second material of the at least one thermal insulation layer has a lower second thermal conductivity than the first thermal conductivity. It is thereby ensured that heat generated by the PTC heating element and transferred to the heat distribution body is not released, or only to a reduced extent, to the environment, at least in the region of the surface of the heat distribution body on which the thermal insulation layer is arranged, but rather remains primarily within the heat distribution body and may be passed on within the latter. The size and/or the arrangement of the thermal insulation layer may be matched to the desired heat conduction behavior in the heat distribution body. The heat conduction device preferably includes a plurality of such thermal insulation layers. In an embodiment, the entire region adjacent to the PTC heating element may be formed with a thermal insulation layer or a plurality of thermal insulation layers. The thermal insulation layer is, in an embodiment, produced from a second material that has a significantly lower second thermal conductivity than the first thermal conductivity, preferably from a second material that has a significantly lower thermal conductivity than metal.

In a further embodiment, the heat conduction device includes at least one heat conduction element which is arranged at least in some regions within the heat distribution body, wherein the heat conduction element is designed to prevent or at least to reduce the release of heat to the environment of the heat distribution body. The heat conduction element therefore influences the heat conduction within the heat distribution body in such a manner that, in the region of the heat conduction element heat is not released, or only to a reduced extent, to the environment, but rather primarily remains within the heat distribution body and may be passed on within the latter. The size and/or the arrangement of the heat conduction element may be matched to the desired heat conduction behavior in the heat distribution body. The heat conduction device preferably includes a plurality of such heat conduction elements. For example, the heat conduction element is produced from an, in one embodiment metallic, second material that has a higher second thermal conductivity than the first thermal conductivity such that it conducts (passes on) the heat well within the heat distribution body. The heat conduction element here in an embodiment is arranged as far as possible inside the heat distribution body, and therefore the distance between the heat conduction element and the surface of the heat distribution body is as large as possible. The heat conduction element may, however, also be produced from a second material, for example, which has a lower second thermal conductivity than the first thermal conductivity such that the heat conduction by the heat conduction element is reduced or prevented. The heat conduction element here may be arranged as close as possible to the surface of the heat distribution body such that thermal insulation is thereby formed within the heat distribution body. The heat conduction agent is expediently cast into the heat distribution body.

The heat distribution body in an embodiment is produced from a metallic first material, for example. In an embodiment, the first material is aluminum. Aluminum has a high thermal conductivity and thus promotes heat conduction and heat distribution within the heat distribution body.

In a further embodiment, the heat distribution body is substantially pot-shaped. In an embodiment, such a heat distribution body is inserted from below into an opening on the bottom of the vehicle tank and, in the mounted state, extends with its substantially circular-cylindrical wall and its bottom from the bottom of the vehicle tank into the interior of the vehicle tank. Such a configuration enables heat dissipation over a large area and thus a large heat flow to the reducing agent and therefore further contributes to a reliable and rapid heating of the reducing agent.

The second object is achieved according to the invention by the features also described.

The vehicle tank according to the invention for a motor vehicle is designed to store a reducing agent which is introduced into an exhaust tract of the motor vehicle for exhaust gas aftertreatment. The vehicle tank has a heating device according to the invention.

The preferred embodiments described for the heating device according to the invention also apply correspondingly to the vehicle tank according to the invention.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Exemplary embodiments of the invention will be explained in more detail below with reference to a drawing, in which:

FIG. 1 shows a schematic sectional illustration of a heating device, and

FIG. 2 shows a schematic sectional illustration of a vehicle tank with a heating device in an alternative embodiment.

Mutually corresponding parts are always provided with the same reference symbols in all figures.

### DETAILED DESCRIPTION OF THE PREFERRED EMBODIMENTS

The following description of the preferred embodiment(s) is merely exemplary in nature and is in no way intended to limit the invention, its application, or uses.

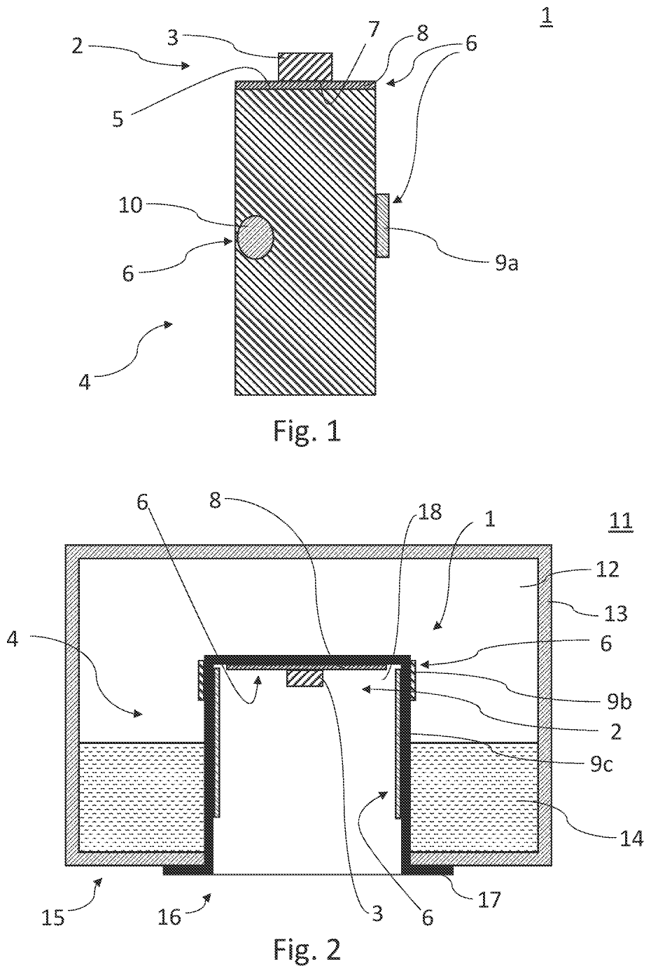

FIG. 1 illustrates a schematic sectional illustration of an exemplary embodiment of a heating device 1. The heating device 1 includes an electrical heating element 2 which includes a PTC heating element 3 and a heat distribution body 4 made of aluminum. The PTC heating element 3 lies in thermal contact on a contact surface 5 of the heat distribution body 4.

The PTC heating element 3 may be supplied with electrical energy via electrical connecting lines (not shown in FIG. 1) and converts electrical energy into heat during operation. The PTC heating element 3 has a dependence of the electrical resistance on the temperature. The PTC heating element 3 thus has a low electrical resistance at low temperatures, which multiplies exponentially when a defined switching temperature is exceeded. When the switching temperature is reached, the current through the PTC element 3 is reduced, with the heat output being reduced accordingly.

The heat distribution body 4 has a heat conduction device 6 which is arranged on and in the heat distribution body 4. The heat conduction device 6 is formed from a second material which has a second thermal conductivity different from aluminum and is designed to distribute heat generated by the PTC heating element 3 in a targeted manner within the heat distribution body 4.

For this purpose, a coupling element 8 is arranged between a side surface 7, facing the contact surface 5, of the PTC heating element 3 and the contact surface 5. The coupling element 8 is designed as a metal sheet with a higher second thermal conductivity than aluminum. In addition, the coupling element 8 is designed to be larger in area than the side surface 7, facing the contact surface 5, of the PTC heating element 3, and therefore a large contact area is formed between the contact surface 5 of the heat distribution body 4 and the coupling element 8, via which heat is dissipated from the coupling element 8 to the heat distribution body 4. In this way, a good thermal coupling of the PTC heating element 3 to the heat distribution body 4 and as targeted an introduction of the heat into the heat distribution body 4 as possible may be provided.

Furthermore, a thermal insulation layer 9a is arranged in some regions on the surface of the heat distribution body 4. The thermal insulation layer 9a is produced from a second material which has a lower second thermal conductivity than aluminum. It is thereby ensured that heat generated by the PTC heating element 3 and transferred to the heat distribution body 4 is not released, or only to a reduced extent, to the environment, at least in the region of the surface of the heat distribution body 4 on which the thermal insulation layer 9a is arranged, but rather remains primarily within the heat distribution body 4 and may be passed on within the latter.

In addition, a heat conduction element 10 is arranged in some regions within the heat distribution body 4 near the surface of the heat distribution body 4. The heat conduction element 10 is designed to prevent or at least to reduce the release of heat to the environment of the heat distribution body 4. The heat conduction element 10 therefore influences the heat conduction within the heat distribution body 4 likewise in such a manner that, in the region of the heat conduction element 10, heat is not released, or only to a reduced extent, to the environment, but rather primarily remains within the heat distribution body 4 and may be passed on within the latter. The heat conduction element 10 is produced from a second material which has a lower second thermal conductivity than aluminum such that the heat conduction by the heat conduction element 10 is prevented or reduced.

The targeted distribution of heat within the heat distribution body 4, influenced by the heat conduction device 6, and enables the heat conduction to extend over the entire heat distribution body and thus the heat distribution body 4 is heated as completely as possible. As a result, a surface area that is as large as possible of the heat distribution body 4 is available for dissipating the heat. This contributes to the fact that the heat flow introduced by the PTC heating element 3 into the heat distribution body 4 corresponds approximately to the heat flow that is released by the heat distribution body 4 to the environment and/or to the reducing agent, as a result of which the risk of “switching off” of the PTC heating element 3 due to an excessively high temperature is significantly reduced and a heat output which is as reliable and uniform as possible may be achieved.

FIG. 2 shows a schematic sectional illustration of a vehicle tank 11 with a heating device 1 in an alternative embodiment. The heating device 1 substantially corresponds to the heating device 1 illustrated in FIG. 1, wherein the heat distribution body 4 is substantially pot-shaped.

Reducing agent 14 is located in an inner region 12 of the vehicle tank housing 13. In the region of the bottom 15 of the vehicle tank 11, an opening 16 is provided, through which the heating device 1 is positioned so as to protrude into the inner region 12 of the vehicle tank 11. The heat distribution body 4 has a circumferential collar-like contact section 17 which is arranged on the outside in a sealing manner against the bottom 15 of the vehicle tank 11. The heat distribution body 4 thus separates a drying space 18 from the inner region 12 of the vehicle tank 11 which is filled with reducing agent 14. A delivery module (not illustrated) for delivering the reducing agent 14 may be accommodated in this drying space 18.

The heat conduction device 6 of the heat distribution body 4 includes the coupling element 8, which is arranged directly between the PTC heating element 3 and the heat distribution body 4, as well as two differently sized thermal insulation layers 9b, 9c, which are arranged in some regions of the surface of the heat distribution body 4. One thermal insulation layer 9b is arranged here on the surface of the heat distribution body 4 facing the inner region 12 of the vehicle tank 11 and the other thermal insulation layer 9c is arranged on the surface of the heat distribution body 4 facing the drying space 18.

The pot-shaped configuration of the heat distribution body 4 enables heat dissipation over a large area and thus a relatively large heat flow to the reducing agent 13 and thus further contributes to a reliable and rapid heating of the reducing agent 13.

The different features of the individual exemplary embodiments may also be combined with one another. The exemplary embodiments of FIGS. 1 and 2 are not of a restrictive nature and serve to illustrate the concept of the invention.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A heating device for installation in a vehicle tank for reducing agent, which is introduced into an exhaust tract of a motor vehicle for exhaust gas aftertreatment, comprising:
at least one electrical heating element, at least one electrical heating element includes at least one PTC heating element;
a heat distribution body formed from a first material which has a first thermal conductivity, the PTC heating element arranged in thermally conductive contact with the heat distribution body such that the heat distribution body is configured to transport and release heat generated by the PTC heating element; and
a heat conduction device is arranged on and/or in the heat distribution body;
wherein the heat conduction device is formed from a second material which has a second thermal conductivity different from the first thermal conductivity, and the heat conduction device distributes heat from the PTC heating element in a targeted manner within the heat distribution body.

2. The heating device of claim 1, further comprising:
a contact surface being part of the heat distribution body, the PTC heating element located on a portion of the contact surface;
a side surface being part of the PTC heating element, the side surface facing the contact surface; and
a coupling element being part of the heat conduction device, the coupling element arranged directly between the side surface and the contact surface;
wherein the second material of the coupling element has a higher second thermal conductivity than the first thermal conductivity.

3. The heating device of claim 2, the coupling element further comprising a metal body.

4. The heating device of claim 2, the coupling element further comprising a metal foil.

5. The heating device of claim 2, the coupling element further comprising a metal sheet.

6. The heating device of one of claim 1, the heat conduction device further comprising:
at least one thermal insulation layer which is arranged at least in some regions on the surface of the heat distribution body;
wherein the second material of the at least one thermal insulation layer has a lower second thermal conductivity than the first thermal conductivity.

7. The heating device of claim 1, the heat conduction device further comprising:
at least one heat conduction element which is arranged at least in some regions within the heat distribution body;
wherein the heat conduction element is designed to prevent or at least to reduce the release of heat to the environment of the heat distribution body.

8. The heating device of claim 1, the first material further comprising aluminum.

9. The heating device of claim 1, wherein the heat distribution body is substantially pot-shaped.

10. The heating device of claim 1, wherein the vehicle tank is part of a motor vehicle, and the vehicle tank stores a reducing agent which is introduced into an exhaust tract of the motor vehicle for exhaust gas aftertreatment.
